(19) United States
(12) Patent Application Publication
(10) Pub. No.: US 2009/0145762 A1
(43) Pub. Date: Jun. 11, 2009

(54) SYSTEM FOR TWO-DIMENSIONAL (2D) GEL ELECTROPHORESIS

(75) Inventor: Thomas Pohl, Berlin (DE)

Correspondence Address: JOYCE VON NATZMER;PEQUIGNOT + MYERS LLC, 200 Madison Avenue, Suite 1901, New York, NY, 10016, US

(73) Assignee: WITA GMBH, TELTOW (DE)

(21) Appl. No.: 12/065,044

(22) PCT Filed: Aug. 18, 2006
(86) PCT No.: PCT/DE06/01456

§ 371 Date: Jul. 10, 2008

(30) Foreign Application Priority Data
Aug. 27, 2005 (DE) 102005041638.1

(51) Int. Cl. G01N 27/447; B29C 51/00

(52) U.S. Cl. 204/606; 264/239

(57) ABSTRACT

The invention relates to a system for two-dimensional gel electrophoresis, wherein in at least one dimension of the electrophoresis, the functional core part thereof is formed essentially of Corian material. Furthermore, at least one electrode is preferably designed in a mobile manner in the first dimension, so that it can be adapted to varying lengths of gel.

The invention relates to a system for two-dimensional gel electrophoresis, wherein in at least one dimension of the electrophoresis, the functional core part thereof is formed essentially of Corian material. Furthermore, at least one electrode is preferably designed in a mobile manner in the first dimension, so that it can be adapted to varying lengths of gel.

Prior art electrophoresis has been employed as an efficient and gentle method e.g. in the separation of proteins or amino acids, but also of whole cells. It utilizes the variable deflection of charged particles in an electric field to achieve a separation effect. The degree of deflection is primarily influenced by the strength of the field between two electrodes and by the electric mobility of the particles to be separated. The level of mobility depends on various quantities, such as charge and size of the particles to be separated, as well as pH value, viscosity and ionic strength of the buffer solution. Traditional one-dimensional methods of polyacrylamide gel electrophoresis (PAGE) are capable of separating a maximum of about 100 proteins in a single sample, for which reason they are not suitable for the analysis of complex protein mixtures, such as encountered in cell extracts.

At present, two-dimensional electrophoresis is the most efficient technique for separating complex protein mixtures. It separates the proteins according to two different parameters, i.e. the isoelectric points (pI in the first dimension) and the electrophoretic mobility (in the second dimension). There are a variety of uses of 2D electrophoresis. Thus, for example, protein patterns are analyzed in various organisms and cell types. Purities of protein fractions are examined, and isoelectric points, molecular weights of subunits and the number of isoforms are determined. The two-dimensional gel electrophoresis system, which furnishes best resolution for the separation of complex protein mixtures, combines the technique of isoelectric focusing (IEF) in the presence of urea and a neutral detergent in the first dimension with plate gel electrophoresis under denaturing conditions using sodium dodecylsulfate (SDS) in the second dimension (O'Farrell, P. H. (1975), J. Biol. Chem. 250, 4007-4021). The separating system uses two independent protein properties: one of them is the charge reflected by the isoelectric point (pI), the other one is the molecular weight which determines the mobility of the SDS-protein complexes in polyacrylamide gels. O'Farrell has demonstrated the great potential of this technique for the first time, being able to resolve more than 1,000 polypeptides in cellular extracts. However, in an IEF/SDS system using carrier ampholytes, basic proteins are not separated adequately because migration thereof into the IEF gel is generally poor. Even when using more basic ampholytes, the expanse of the pH gradient in the basic range is small because, due to the cathode drift, the actual gradient does not significantly rise above pH 7.5. Furthermore, the small number of basic proteins entering the IEF gel under these conditions invariably give rise to streaks. However, this problem can be avoided by using the non-equilibrium pH gradient electrophoresis (NEPHGE) in the first dimension, as described by O'Farrell.

The main difference between NEPHGE and IEF is that the samples in the former case are applied to the acid side of the gel and that the voltage×time product is smaller than that in the IEF. Under such conditions, the pH gradient does not reach full equilibrium. As a result, the proteins are not completely focused at their isoelectric point, as is the case in the IEF. Nevertheless, most proteins are separated according to their differing charges in NEPHGE gels as well.

The well-known systems used in two-dimensional electrophoresis suffer from a number of drawbacks: regarding safety, the first dimension is not sufficiently protected from the high voltages being used; furthermore, many systems are required for the different lengths of gel, and, in addition, the apparatus for the second dimension are not easy to handle; for example, they are not stackable, thus highly space-demanding, and consume a lot of chemicals.

The invention solves this problem by means of a system in accordance with the claims.

In the inventive system for two-dimensional gel electrophoresis, at least one functional core part is formed essentially of Corian material. For example, the functional core part can be the plate on which the gel is positioned in the second dimension. The Corian material may have drill-holes incorporated therein which represent the cooling system. In this way, the system can adopt a more compact design. More specifically, the apparatus for the second dimension can be stacked horizontally and consume less chemicals.

The system comprises at least two components for the first and the second dimension of the electrophoresis, respectively, the first dimension comprising an electrode which can be adapted to different lengths of the gels, the first dimension being surrounded by a jacket body made of plexiglass, comprising at least one door with an NO contact for a circuit, and the second dimension of the gel electrophoresis being made essentially of Corian material. Such a system is advantageous in that the circuit is interrupted when opening the door or doors and closed when locking the doors. For example, interruption of the circuit via a contact on the door and a corresponding contact at the base of the apparatus can be envisaged for the first dimension.

It is preferred that the material is Corian Glacier White.

In a preferred embodiment of the invention, at least one electrode in the first dimension is positioned on a movable carriage on a contact arm.

The invention also relates to the use of Corian for the production of a system of gel electrophoresis, especially for the production of functional components.

This material has the advantage of being malleable, formable, and thus shapeable, e.g. for integrating cavities and canals which—likewise by way of example, but not exclusively—can be used for cooling purposes. Comparable systems normally use glass which is known to be immalleable.

The above-mentioned two components used to perform the electrophoresis in the first and the second dimension are separate electrophoresis units. Therefore, according to the invention, an electrophoresis unit used to perform the first dimension of a two-dimensional gel electrophoresis is also a subject matter of the invention, comprising an electrode which can be adapted to different lengths of the gels, the first dimension being surrounded by a jacket body made of plexiglass, comprising at least one door with an NO contact for a circuit.

The invention is also directed to an additional electrophoresis unit used to perform the second dimension of a two-dimensional gel electrophoresis, which is formed essentially of Corian material. Owing to the flat design with optionally integrated cooling, it can be stacked horizontally, thus saving space to a large extent, which is particularly advantageous in situations involving narrow laboratories. Also, the consumption of chemicals is reduced to a large extent.

Without intending to be limiting, the invention will be explained below with reference to an example.

The figures show:

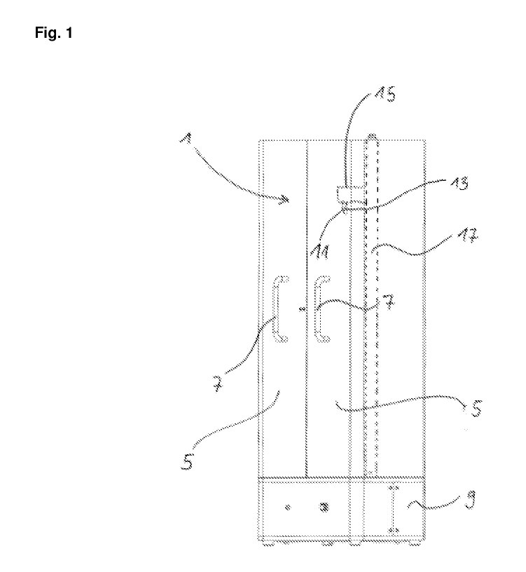

FIG. 1: apparatus for first dimension with plexiglass casing;

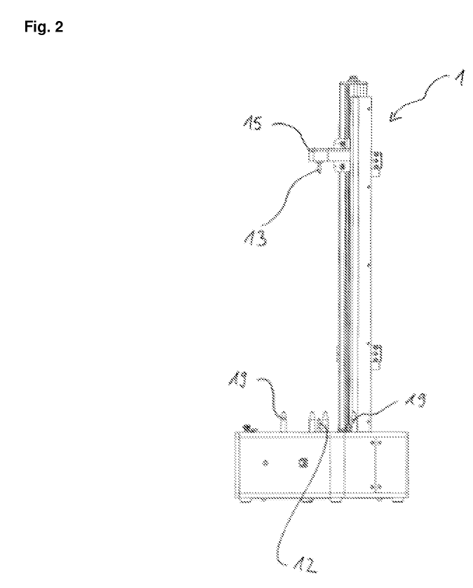

FIG. 2: contact arm (first dimension);

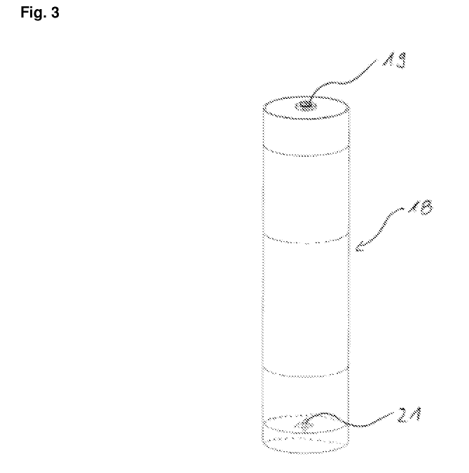

FIG. 3: electrophoresis unit;

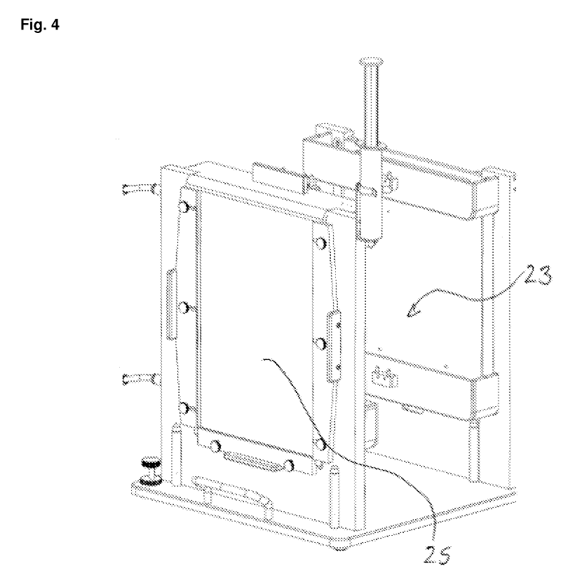

FIG. 4: front view second dimension;

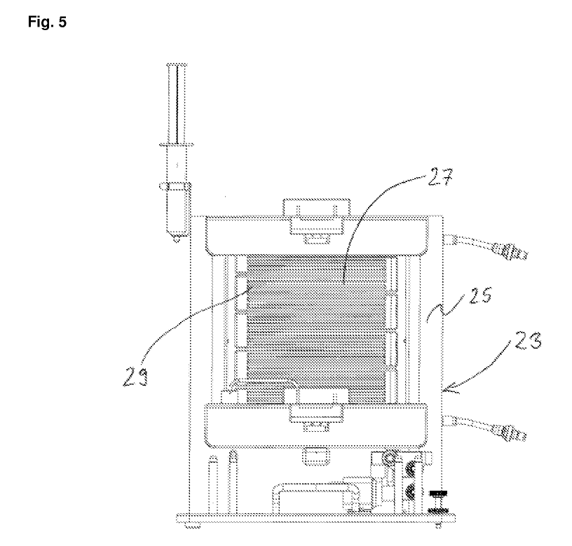

FIG. 5: rear view second dimension (open);

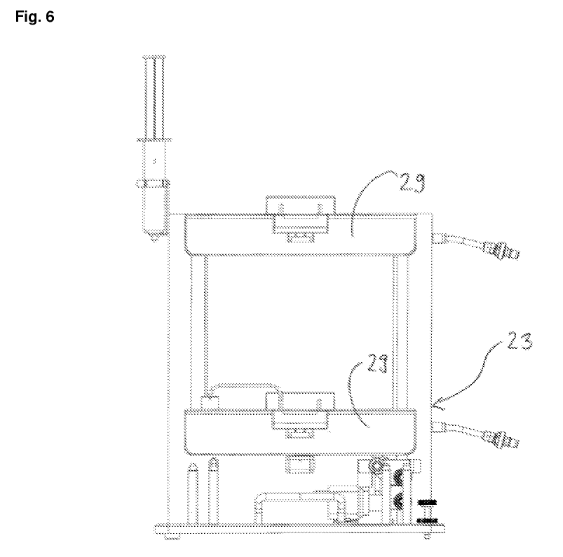

FIG. 6: rear view second dimension (closed);

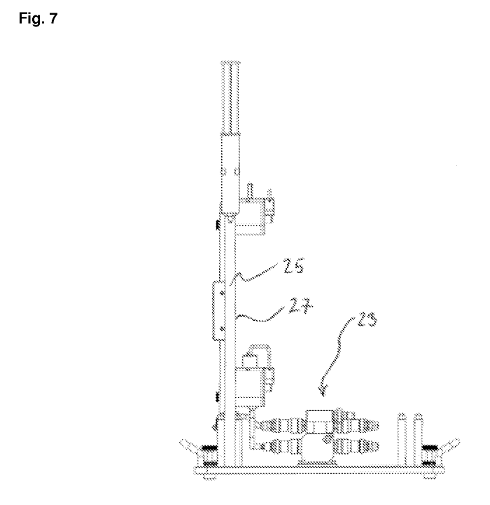

FIG. 7: side view second dimension.

FIG. 1 shows an apparatus/electrophoresis chamber (1) for performing the first dimension of the gel electrophoresis. More specifically, the apparatus (1) for performing the gel electrophoresis in the first dimension has a jacket (3) preferably made of plexiglass. The jacket (3) of the apparatus (1) is preferably designed in such a way that two doors (5) are present. Opening the doors (5) using the handles (7) separates a contact on the door (not shown) from a corresponding contact (not shown) at the base (9) of the apparatus (1). Thus, a circuit is opened when opening the door (5) and closed when closing the doors (5).

FIG. 1 also shows two electrodes (11) of the apparatus (1), the electrode (13) being mounted on a carriage (15) which can be vertically shifted up and down on a contact arm (17). Depending on the size of the gel, the contact arm (17) and the electrode (13) can be adjusted in such a way that gels of varying size can be used with one and the same apparatus (1).

FIG. 2 shows the apparatus (1) without jacket (3). Omitting the jacket (3) allows a view on the design of the carriage (15) having the upper electrode (13) mounted thereon. The bolts (19) are used for better positioning of the electrophoresis unit—as illustrated in FIG. 3—such that the contacts of the electrophoresis unit and lower electrode (12) can be contacted in such a way that the circuit is closed as soon as the upper electrode (13) is connected with the upper contact point and the doors (5) are closed.

FIG. 3 shows the above-mentioned electrophoresis unit with the upper contact point (19) and the lower contact point (21). Filling the electrophoresis unit with gel or buffer solutions creates a conductive arrangement wherein biomolecules can be separated by applying a current. The electrophoresis unit (18) can be placed in the apparatus (1) to carry out an electrophoretic separation in the first dimension.

Advantageously, further separation of the biomolecules is effected in the second dimension as explained above.

FIG. 4 shows the front view of a device (23) for performing the second dimension. The functional core part (25) of the device (23) is made of Corian.

FIG. 5 shows an open rear view of the device (23). The functional core part (25) has the cooling (27) incorporated therein. The cooling (27) is designed in the form of a cooling system (29). The cooling system (29) can be produced by internal shaping of the Corian material. That is, the cooling system does not have to be mounted on the device (23) as a separate system, but is a component thereof. As a result, the device (23) is very easy to handle, it can be stacked horizontally and consumes substantially less chemicals than conventional devices.

FIG. 6 shows a closed rear view of the device (23). The flat design of the device (23) is clearly visible in this figure. The functional core part (25) is designed so as to be very flat and occupy very little space. The containers (29) for the solutions are directly fitted to the functional core part (25) of the device (23), which includes the cooling (27).

FIG. 7 shows a side view of the device (23). In this illustration, the feed and discharge lines for buffer solutions and cooling agents are clearly visible which, however, do not reflect the basic point of the invention and therefore require no further discussion, particularly since they are well-known to those skilled in the field of electrophoretic technology.

### LIST OF REFERENCE NUMBERS

1) Apparatus for first dimension
3) Jacket, preferably made of plexiglass
5) Doors
7) Handles
9) Base
11) Electrode
12) Lower electrode
13) Upper electrode
15) Carriage
17) Contact arm
18) Electrophoresis unit
19) Upper contact point
21) Lower contact point
23) Device for second dimension
25) Functional core part
27) Cooling
29) Containers

1. A system for two-dimensional gel electrophoresis comprising a first and a second dimension, wherein in at least one of said dimensions of the electrophoresis, a functional core part consists essentially of Corian material.

2. The system according to claim 1, comprising at least two components for the first and the second dimension of the electrophoresis, respectively,
the first dimension comprising an electrode which can be adapted to different lengths of gels, and wherein the first dimension is surrounded by a jacket body made of plexiglass, comprising at least one door with an NO contact for a circuit, and
the second dimension of consisting essentially of Corian material.

3. The system according to claim 1, wherein the Corian material has a cooling system incorporated therein.

4. The system according to claim 1, wherein the Corian material is Corian Glacier White.

5. The system according to claim 2, wherein, the electrode in the first dimension is positioned on a movable carriage on a contact arm.

6. (canceled)

7. An electrophoresis unit for performing a first dimension of a two-dimensional gel electrophoresis the unit comprising an electrode which can be adapted to different lengths of gels, and wherein the first dimension is surrounded by a jacket body made of plexiglass, comprising at least one door with an NO contact for a circuit.

8. An electrophoresis unit for performing a second dimension of a two-dimensional gel electrophoresis the second dimension consisting essentially of Corian material.

9. The electrophoresis unit according to claim 8, comprising a design, wherein said design allows horizontal stacking of said electrophoresis unit.

10. The system according to claim 2, wherein the Corian material has a cooling system incorporated therein.

11. The electrophoresis system of claim 1, wherein said Corian material comprises integrated cavities and/or canals.

12. The electrophoresis system of claim 11, wherein said system is cooled via integrated cavities and/or canals.

13. A method of producing an electrophoresis system comprising,
providing Corian for the production of said system,
shaping said Corian, and
producing functional components of said electrophoresis system.

14. The method of claim 13, wherein said Corian is shaped to integrate canals and/or cavities.
